(19) United States
(12) Patent Application Publication
(10) Pub. No.: US 2024/0166804 A1
(43) Pub. Date: May 23, 2024

(54) Oligoesters Comprising Resorcinol and Iso- and/or Terephthalic Acid, Corresponding Polyester Carbonates and Their Preparation

(71) Applicant: Covestro Deutschland AG, Leverkusen (DE)

(72) Inventors: Alexander Meyer, Düsseldorf (DE); Lukas Fabian Schulz, Köln (DE); Thomas Pfingst, Tönisvorst (DE); Ulrich Liesenfelder, Bergisch Gladbach (DE); Dirk Hinzmann, Pulheim (DE)

(21) Appl. No.: 18/570,189

(22) PCT Filed: Jun. 10, 2022
(86) PCT No.: PCT/EP2022/065837

§ 371 Date: Dec. 14, 2023

(30) Foreign Application Priority Data
Jun. 15, 2021 (EP) 21179513.3
Nov. 24, 2021 (EP) 21210114.1
Apr. 29, 2022 (EP) 22170693.0

(51) Int. Cl. C08G 63/183; C08G 63/64; C08G 64/30

(52) U.S. Cl. CPC C08G 63/183; C08G 63/64; C08G 64/30

(57) ABSTRACT

The present disclosure relates to a mixture including oligoesters as described herein. The present disclosure relates to polyester carbonates including an ester block as described herein, and the present disclosure also relates to a process for preparing polyester carbonates having an ester block by melt transesterification as described herein.

### CROSS-REFERENCE TO RELATED APPLICATIONS

This application is the United States national phase of International Application No. PCT/EP2022/065837 filed Jun. 10, 2022, and claims priority to European Patent Application Nos. 21179513.3 filed Jun. 15, 2021, 21210114.1 filed Nov. 24, 2021, and 22170693.0 filed Apr. 29, 2022, the disclosures of which are hereby incorporated by reference in their entireties.

### BACKGROUND

### Technical Field

The present invention relates to a mixture comprising oligoesters, to polyester carbonates comprising an ester block, and a process for preparing polyester carbonates having an ester block.

### Description of Related Art

It is known that aromatic polyester carbonates have good properties with regard to mechanical properties and heat distortion resistance. It is also known that specific polyester carbonates, especially when they contain ester blocks formed from aromatic diacids and resorcinol, have high weathering resistance.

In particular, it is known that polyester carbonates containing ester blocks formed from iso- and/or terephthalic acid and resorcinol have good weathering resistance. These materials are of interest particularly because they do not require any painting to protect them from harmful weathering influences and especially from UV light. The ester structures formed from resorcinol and iso- and/or terephthalic acid can enter into what are called photo-Fries rearrangements on contact with UV light. This forms hydroxybenzophenone structures incorporated within the polymer chain. It is known that hydroxybenzophenones have UV absorption properties. This explains the good weathering resistance. This subject matter is described, for example, in US20030050400 A1. By contrast, the alternative use of UV absorbers is far less effective since the majority of the UV absorber accumulates in the bulk. The concentration of UV absorber at the surface that has to be protected against UV light in particular is relatively low. If the person skilled in the art would like to use higher concentrations of UV absorber, they are confronted by further drawbacks. For instance, low molecular weight compounds lower the mechanical properties, especially in relatively high concentrations. This is undesirable. In order to anchor relatively high concentrations of UV absorber in the surface, it is customary to protect UV-sensitive materials such as polycarbonate by means of paint layers having high concentrations of UV absorber. However, painting is an additional step that incurs costs and is also not always the preferred solution for reasons of sustainability. Especially in the field of automobile applications, it is advantageous when materials are intrinsically weathering-stable and it is possible to dispense with laborious painting.

The polyester carbonates described are produced in the prior art by an interfacial process. In this process, aromatic diols and OH-terminated ester blocks are incorporated by condensation by means of phosgene. The OH-terminated ester blocks may likewise be prepared in solution by condensation with phosgene proceeding from aromatic diacids and aromatic diols. Such a process for preparing the oligoesters and the corresponding polyester carbonates is described in WO0026275 A1. This document describes, as preferred polymers, polyester carbonates formed from bisphenol A-containing ester blocks formed from terephthalic/isophthalic acid. The ester blocks are prepared here in a dichloromethane/water mixture using aqueous NaOH solution proceeding from the acid chlorides of the aromatic diacid and resorcinol. The polyester solution containing hydroxy-terminated ester blocks is transferred to a phosgenation reactor. Alkaline bisphenol A solution is introduced in the preferred case, and the reactants are reacted with phosgene.

Processes based on the melt transesterification process which is known for polycarbonate are known and have the advantage that it is possible to avoid feedstocks that are difficult to handle, for example phosgene. Moreover, they have the great advantage of being able to dispense with solvents. It would therefore be industrially advantageous to prepare polyester carbonates by the melt transesterification process. However, this process too includes challenges. For instance, the high-reactivity acid chlorides can be replaced only with difficulty by other feedstocks. Transesterification processes frequently have long dwell times in corresponding reactors. On account of the high temperatures, there is frequently formation of decomposition products that adversely affect product quality. Since melt transesterification processes normally do not need complex workup steps, impurities including catalyst residues remain in the product. These can worsen product quality.

Moreover, polycarbonates that are prepared by the melt transesterification process will have distinctly higher contents of hydroxy-terminated end groups (phenolic OH group content) compared to corresponding products from the interfacial process. These phenolic OH groups can be damaged by oxidative processes, which worsens product quality. This especially affects the optical properties. However, especially in the case of a product that is to feature high intrinsic weathering resistance, it is important to obtain good optical properties. It is therefore advantageous when the phenolic OH end group content is low. In this regard, however, there is no teaching in the prior art in relation to the polyester carbonates mentioned, since the prior art relates exclusively to the preparation of the polyester carbonates by means of interfacial reaction. Thus, the person skilled in the art does not know how such polyester carbonates with low OH end group content should be prepared by the melt transesterification process.

Since, for reasons mentioned above, the reactivity of the reactants is lower compared to the feedstocks in the interfacial process, it is additionally unknown how abovementioned polyester carbonates having high viscosity or molecular weight can be prepared.

WO2005021616 A1 describes the preparation of hydroxy-terminated oligoester blocks in the melt. What was examined here is how it is possible to achieve an OH end group content of the oligoesters comparable to oligoesters that can be obtained in a process with a solvent. Likewise tested for this purpose were different catalysts, and the effect of the mode of operation (for example different temperatures and reduced pressure). The resulting molecular weights of the oligoesters are relatively low. Although what are described here are oligoesters having phenoxy end groups, WO2005021616 A1 does not describe any molecular weight distribution of the oligomers of the oligoester. In addition, the oligoesters are subsequently incorporated by condensation by means of an interfacial process to give a polyester carbonate. Thus, this document cannot contain any teaching as to how end groups and/or oligomer distributions affect the preparation of a polyester carbonate by melt transesterification.

In WO2006057810 A1, oligoesters are prepared by the melt transesterification process, which are characterized in that they have a high proportion of carboxyl end groups. These carboxyl end groups are then utilized to incorporate the oligoesters into paint systems. However, the free acids are comparatively unreactive in a melt transesterification process for preparation of a polyester carbonate, and so these precursors are unsuitable for the melt-based polyester carbonates mentioned. There is accordingly no description here of use in a melt transesterification process.

US20030050400 A1 describes the preparation of oligomers from aromatic diacids and resorcinol. The problem addressed by US20030050400 A1 is that of providing OH-terminated units that can then be converted to polyester carbonates by interfacial processes. Similarly to WO2005021616 A1, what is not addressed here is an oligomer distribution, the end group ratio or the influence thereof on melt transesterification of the oligoesters.

### SUMMARY

Proceeding from this prior art, the problem addressed by the present invention was that of overcoming at least one disadvantage of the prior art. More particularly, the problem addressed by the present invention was that of providing a polyester carbonate comprising ester blocks based on isophthalic acid and/or terephthalic acid and resorcinol, which are obtainable by a melt transesterification process. What should preferably be obtained here are polyester carbonates that have good processibility and simultaneously have a minimum phenolic OH end group content. Thus, the polyester carbonates should preferably be weathering-stable and/or else essentially yellowing-stable and/or essentially not have a tendency to polymer degradation, for example via oxidative degradation. It is likewise preferable that no raw materials that present challenges in handling, for example phosgene, are used in the preparation of the polyester carbonate.

At least one and preferably all of the abovementioned problems have been solved by the present invention. It has been found that, surprisingly, only when the oligoester has a defined end group content and a defined proportion of small oligomers can a processible polyester carbonate be provided via a melt transesterification process. Only when a mixture containing oligoesters with not more than 0.5% by weight of OH end groups such as phenolic OH end groups is used (where the radical in the end groups is essentially a specific aromatic radical, preferably phenyl) and the proportion of oligomers having a molecular weight of less than 1000 g/mol is low is it possible to obtain a polyester carbonate by melt transesterification that has a high molecular weight (but not too high) and simultaneously has a content of phenolic OH end groups which is sufficiently low that the polyester carbonate has a high stability, for example to degradation. The effect of the use of the specific polyester carbonates is that a novel polyester carbonate is obtained, in which the isophthalic acid and/or terephthalic acid groups are to a high degree bonded directly to the carbonate blocks. In the prior art, the oligoesters are used with a maximum OH end group content. The effect of this is automatically that the diol used (for example resorcinol) forms the end group of these oligoesters. These then bind to the carbonate blocks, which give rise, for example, to carbonate-resorcinol linkages. By contrast, the oligoesters according to the invention are terminated essentially by specific aromatic esters of isophthalic acid and/or terephthalic acid. The effect of this is that the polyester carbonates have novel linkages via the isophthalic acid and/or terephthalic acid. By virtue of the provision of the specific oligoesters, a polyester carbonate was thus obtainable from an oligocarbonate and an oligoester block by melt transesterification, which has good properties with regard to the objectives required above.

The invention therefore provides a mixture comprising oligoesters of the formula (1)

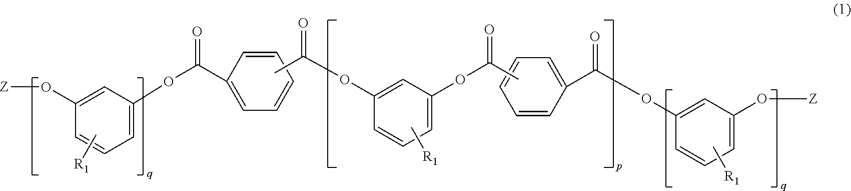

where
each R₁ is independently a hydrogen atom, a halogen or an alkyl group having 1 to 4 carbon atoms, each q is independently 0 or 1,
if q=1: each Z is independently —H or an aromatic radical of the formula (2a)

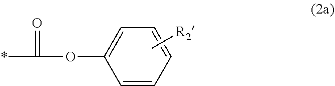

where R_{2′} is hydrogen or is —COOCH₃ and “*” indicates the position by which the formula (2a) is bonded to the oxygen atom in the formula (1),
if q=0: each Z is independently an aromatic radical of the formula (2)

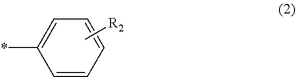

where R₂ is hydrogen or is —COOCH₃ and “*” indicates the position by which the formula (2) is bonded to the oxygen atom in the formula (1), and
p indicates the number of repeat units,
   characterized in that not more than 0.5% by weight of the Z radicals in relation to the mixture are hydrogen and in that the percentage of oligomers having a molecular weight of less than 1000 g/mol in the mixture is less than 12%, preferably less than 10%, where the percentage of oligomers is determined by the ratio of the area beneath a molecular weight distribution curve of the mixture in relation to the refractive index signal (from gel permeation chromatography) within a range below 1000 g/mol and the total area beneath that molecular weight curve, and where the gel permeation chromatography is conducted in dichloromethane with a bisphenol A polycarbonate standard.

According to the invention, the expression “mixture comprising oligoesters of the formula (1)” should be understood such that this mixture consists essentially of the oligoesters of the formula (1). This preferably means that at least 80% by weight, more preferably at least 90% by weight, most preferably at least 95% by weight, of the mixture consists of the oligoesters of the formula (1). However, as a result of the preparation, it cannot be ruled out that the mixture also includes a certain proportion of oligoesters that have the formula (1) but where at least one q=0 and Z in that case, at this chain end of the oligoester where q=0, is a hydrogen. In this case, R₁ and p have the definitions given above. This means that the oligoester is terminated at least on one side by an isophthalic acid/terephthalic acid (—COOH as end group).

In the case in which oligoesters of the formula (1) in which at least one q=0 and Z in that case, at this chain end of the oligoester where q=0, is hydrogen are present in the mixture according to the invention, these OH end groups (—COOH end groups) are not included in the defined percentages by weight of OH end groups (via Z in formula (1)) in the mixture according to the invention. Preferably, the proportion of —COOH end groups (via the case that, in formula (1), at least one q=0 and Z at the chain end of the oligoester where q=0 is a hydrogen) in the mixture according to the invention is not more than 10% by weight, more preferably not more than 8% by weight, even more preferably not more than 5% by weight and most preferably not more than 2% by weight in relation to the total weight of the mixture. The person skilled in the art knows how these —COOH end groups can be determined. In particular, it is possible to determine the carbon atoms that are part of the acid end group via C¹³ NMR measurements. For this purpose, deuterated DMSO in particular is a suitable solvent. The carbon atoms that are part of the acid end group should generally be within a range from 160 to 170 ppm, especially 163 to 169 ppm. It is preferable in accordance with the invention that the content of formula (1) in which at least one q=0 and Z at the chain end of the oligoester where q=0 is hydrogen in the mixture according to the invention is low.

It is preferable in accordance with the invention that the mixture includes a total of not more than 0.5% by weight, preferably not more than 0.45% by weight, more preferably not more than 0.4% by weight, most preferably not more than 0.35% by weight, of OH end groups in relation to the total weight of the mixture (preferably detected via ¹H NMR).

Preferably, R₁ in formula (1) is hydrogen. This means that the ring substituted by the R₁ is preferably derived from resorcinol.

Preferably, R₂′ in formula (2) is hydrogen. This means that the groups on which the R₂ is present in the formula (2), in combination with the formula (1), are preferably phenyl isophthalates and/or terephthalates.

Likewise preferably, R₂′ in formula (2a) is hydrogen. This means that the groups on which the R₂′ is present in the formula (2a), in combination with the formula (1), are preferably resorcinol phenylcarbonate.

Especially preferably, R I in formula (1) is hydrogen, R₂ in formula (2) is hydrogen and R₂′ in formula (2a) is hydrogen.

p in formula (1) indicates the number of repeat units of the oligoester. p preferably has an average value of at least 4. More preferably, p in formula (1) has an average of at least 4 and at most 30, more preferably at least 5 and at most 27, most preferably at least 5 and at most 24. It is especially preferable that the mixture of oligoesters has a number-average molar mass in the range from 1300 g/mol to 6000 g/mol, more preferably 1400 g/mol to 5500 g/mol and most preferably 1500 g/mol to 5000 g/mol. This M n is preferably determined via gel permeation chromatography in dichloromethane with a bisphenol A polycarbonate as standard. The molecular weights Mw (weight-average) and Mn (number-average) according to the invention for the oligoesters or polyester carbonates used—unless stated otherwise—were determined by means of size exclusion chromatography (gel permeation chromatography, GPC; in accordance with DIN 55672-1:2007-08 using a BPA polycarbonate calibration). Calibration was effected with linear polycarbonates of known molar mass distribution (for example from PSS Polymer Standards Service GmbH, Germany). This was done by employing method 2301-0257502-09D (from 2009 in German) from Currenta GmbH & Co. OHG, Leverkusen. Dichloromethane was used as eluent. The column combination consisted of crosslinked styrene-divinylbenzene resins. The GPC may comprise one or more series-connected commercially available GPC columns for size exclusion chromatography, selected such that sufficient separation of the molar masses of polymers, in particular of aromatic polycarbonates having weight-average molar masses M_{w} of 2000 to 100 000 g/mol, is possible. The analytical columns typically have a diameter of 7.5 mm and a length of 300 mm. The particle sizes of the column material are in the range from 3 μm to 20 μm.

The mixture according to the invention is preferably characterized in that R₁ in formula (1) is hydrogen, not more than 0.4% by weight of the Z radicals in relation to the mixture are hydrogen, and the percentage of oligomers having a molecular weight of less than 1000 g/mol is less than 10%.

The mixture according to the invention has not more than 0.5% by weight, preferably not more than 0.45% by weight, more preferably not more than 0.4% by weight, most preferably not more than 0.35% by weight, in relation to the overall mixture, of OH end groups (meaning that Z in formula (1) is hydrogen). This OH end group content can be determined in the manner known to the person skilled in the art. The OH end group content is preferably ascertained by ¹H NMR. This can be effected, for example, in dichloromethane with tetramethylsiloxane as internal standard. For this purpose, the area beneath the signal of the OH groups (this is generally at 5.3 to 5.6 ppm) may be expressed in relation to the area of the other signals of the oligomer.

It has been found that, surprisingly, when the OH end group content of the mixture according to the invention is greater than 0.5% in relation to the overall mixture, this mixture of oligoesters is so reactive that melt transesterification affords polyester carbonates having a relative solution viscosity which is no longer processible (i.e. generally above an eta rel of 1.35). Thus, what are obtained are polyester carbonates that can be processed only with difficulty to give moulded articles by injection moulding, for example. At the same time, many of these polyester carbonates thus obtained also have a phenolic OH content. This generally leads to an unstable polymer that has a tendency to degradation via temperature and/or light. If the OH end group content of the mixture according to the invention is not more than 0.5% by weight in relation to the overall mixture, it is possible to obtain, by contrast, polyester carbonates which, on account of their molecular weight (measured as eta rel) and also of their resulting phenolic OH end group content, both have good processibility (for example by injection moulding) and are very stable to degradation.

It is preferable in accordance with the invention that, in relation to the formula (1), the ratio of the end groups in which Z conforms to the formula (2a) and/or the formula (2) to the end groups in which Z is hydrogen (and in this end group q=1) is 10:1 to 2:1, more preferably 9:1 to 3:1 and most preferably 8:1 to 4:1. This ratio of the end groups can be determined in a manner known to the person skilled in the art. In particular, this ratio can be determined by ¹H NMR, preferably at at least 700 MHz. This can be effected, for example, in dichloromethane with tetramethylsiloxane as internal standard. For this purpose, the area beneath the signal of the OH groups (this is generally at 5.3 to 5.6 ppm) may be expressed in relation to the area of the other signals of the oligomer. Depending on the overlap of the peaks and the selection of the monomers forming the oligoester according to the invention, it is also possible, for example, to express the area of the peak at about 7.4 ppm that should correspond to a phenyl end group (2 protons) relative to the area of the peak between 6.6 and 6.8 ppm that should correspond to a resorcinol end group (3 protons).

It has likewise been found that, surprisingly, the proportion of oligomers having a molecular weight of less than 1000 g/mol in the mixture according to the invention must be less than 12%, preferably less than 11%, more preferably less than 10%, in order for there to be a sufficient increase in molecular weight of the polyester carbonate by melt transesterification. If the proportion is greater than 12%, the mixture of oligoesters will not be reactive enough to result in a sufficient increase in molecular weight. This means that the resulting polyester carbonate will not have the desired properties in relation to processibility, mechanical properties and optical properties. According to the invention, the proportion of oligomers having a molecular weight of less than 1000 g/mol is determined by the ratio of the area beneath a molecular weight distribution curve of the mixture in relation to the refractive index signal (from gel permeation chromatography) within a range below 1000 g/mol and the total area beneath that molecular weight distribution curve. Gel permeation chromatography is conducted here in dichloromethane with a bisphenol A polycarbonate standard (see also exact description of gel permeation chromatography above). The curve of refractive index signal versus molecular weight can be integrated in a manner known to a person skilled in the art, especially by the GPC software. The area beneath the curve below 1000 g/mol is expressed here relative to the total area. It will be apparent that the Mn of the mixture of oligoesters has an influence on the amount of oligomers having a molecular weight below 1000 g/mol. This means firstly that, in the case of low Mn values of the oligoesters, there will be a relatively narrow distribution in the molecular weight distribution for the proportion of oligomers having a molecular weight less than 1000 g/mol to be less than 12%. Secondly, this may however also preferably mean that the oligoesters have a relatively high Mn, such that the proportion of oligomers having a molecular weight of less than 1000 g/mol is thus less than 12%.

It is preferable that the mixture according to the invention comprising oligoesters of the formula (1) in all the above-described preferences and combinations of preferences is produced via a process in which
(i) at least isophthalic acid and/or terephthalic acid are mixed with a diol of the formula (3) and at least one diaryl carbonate of the formula (4), where

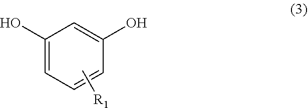

in which R₁ is a hydrogen atom, a halogen or an alkyl group having 1 to 4 carbon atoms, preferably hydrogen, and where

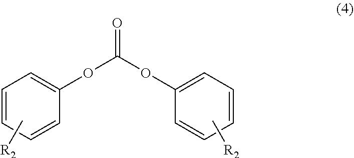

in which R₂ is in each case independently hydrogen or is —COOCH₃, preferably hydrogen,
(ii) this mixture from step (i) is heated in the presence of at least one catalyst and
(iii) reduced pressure is applied to the mixture from step (ii) in order to obtain the mixture comprising oligoesters.

Optionally, this process according to the invention can also be supplemented by a step (iv) in which the mixture obtained, comprising oligoesters, from step (iii) is precipitated. For this purpose, the mixture is preferably dissolved in dichloromethane. Likewise preferably, it can then be precipitated in a nonsolvent, for example methanol. After subsequent separation of the precipitated mixture comprising oligoesters from the nonsolvent and optional drying, the mixture according to the invention comprising oligoesters is obtained. Step (iv) can be used when the proportion of oligomers having a molecular weight of less than 1000 g/mol in the mixture is greater than 12%. The effect of the precipitation is that the oligomers having low molecular weight remain in solution. It is thus possible to reduce the proportion of oligomers having a molecular weight of less than 1000 g/mol in the mixture. Likewise optionally, the process according to the invention may optionally also, in addition to step (iv), include a further step (v) in which the mixture obtained from step (iii) or from step (iv), comprising oligoesters, is reacted with a diacid diphenyl ester, preferably diphenyl isophthalate and/or diphenyl terephthalate. Process step (v) can be employed especially when the OH end group content of the mixture obtained from step (iii) or step (iv), comprising oligoesters, is greater than 0.5% by weight in relation to the mixture. The additional reaction with the diacid diphenyl ester allows at least some of the OH end groups to be converted to phenoxy end groups (i.e. Z in formula (1) is phenyl). In this way, the OH end group content of the mixture comprising oligoesters can be reduced. The person skilled in the art will also be aware of alternative steps (v) in order to reduce the OH end group content. However, the step (v) described is particularly preferred since the introducing of the end groups described leads to reactivity in the subsequent melt transesterification process to give a polyester carbonate.

But it is likewise also possible in accordance with the invention that the choice of suitable parameters and especially also the choice of the suitable catalyst in step (ii), even after step (iii), affords a mixture comprising oligoesters which directly fulfils the features required in accordance with the invention of the OH end group content and of the proportion of oligomers having a molecular weight below 1000 g/mol. Thus, neither step (iv) nor step (v) is needed in that case.

For example, in step (i), it is possible to directly influence the resulting end group ratio in the mixture comprising oligoesters preferably via the ratio of isophthalic acid and/or terephthalic acid to the diol of the formula (3). The ratio of isophthalic acid and/or terephthalic acid to the diol of the formula (3) is preferably 1.00 to 1.15, more preferably 1.03 to 1.13, most preferably 1.04 to 1.12. It has been found that a high proportion of oligomers having a molecular weight below 1000 g/mol is formed in the case of a ratio below 1.00. As already described, these can be removed from the mixture by means of step (iv). However, it is therefore preferable that the ratio is above 1.00. Conversely, an excessively high ratio leads to very high OH end group termination. Here too, it has already been stated that this can be reduced by means of step (v). Nevertheless, it is preferable that the ratio is therefore not more than 1.15.

Preferably, both isophthalic acid and terephthalic acid are used in process step (i). When both diacids are used, it is additionally preferable that the ratio of isophthalic acid to terephthalic acid is 0.25-4.0:1, more preferably 0.4-2.5:1 and most preferably 0.67-1.5:1. It is likewise preferable that the diol of the formula (3) is resorcinol. It is likewise and preferably simultaneously preferable that the diaryl carbonate of the formula (4) is diphenyl carbonate.

Particular preference is given to using a ratio of isophthalic acid and/or terephthalic acid to the diaryl carbonate of the formula (4) of 1:2-2.5, further preferably of 1.0:2.01-2.25, and most preferably of 1.0:2.05.

In process step (ii), the mixture from process step (i) is heated in the presence of at least one catalyst. Preferably, in this process step (ii), the individual constituents from process step (i) are melted. However, terephthalic acid in particular is not soluble at least at the start under the given conditions. However, this can change in the course of process step (ii). In process step (ii), carbon dioxide is generally released. This procedure allows a quick reaction with low thermal stress. Process step (ii) is preferably effected under protective gas atmosphere, preferably under nitrogen and/or argon. Step (ii) is preferably effected in the absence of a solvent. The term “solvent” in this context is known to the person skilled in the art. According to the invention, the term “solvent” is preferably understood to mean a compound that does not enter into a chemical reaction in any of process steps (i), (ii) and/or (iii). This excludes those compounds that are formed by the reaction (for example phenol when the diaryl carbonate used is diphenyl carbonate). It is of course not possible to rule out the presence of traces of solvents in the starting compounds. This eventuality is preferably to be covered by the invention. However, with preference according to the invention, an active step of adding such a solvent is avoided.

The heating in process step (ii) is preferably effected to temperatures of 180° C. to 300° C., preferably 190° C. to 270° C. and especially preferably of 195° C. to 250° C. Under these temperature conditions, it may be the case that the corresponding aryl alcohol of the diaryl carbonate, preferably phenol, is distilled off. Process step (ii) is preferably effected under standard pressure. Preference is given here to stirring under standard pressure until the evolution of gas essentially stops. Alternatively, the temperature can also be increased stepwise—according to the reactivity observed—to 200° C.-300° C., preferably 210-260° C., especially preferably 215-240° C. The reactivity can be estimated from the evolution of gas, in a manner known to the person skilled in the art. Although higher temperatures are in principle also possible in this step, side reactions (e.g. discoloration) can occur at higher temperatures. Higher temperatures are therefore less preferable.

It has been found that the at least one catalyst used in process step (ii) can influence the oligomer distribution of the mixture according to the invention comprising oligoesters. It is possible (also) to use a catalyst containing alkali metal ions, preferably sodium ions, in process step (ii). However, the alkali metal ions remain in the mixture according to the invention. This is to be condensed thereafter by means of melt transesterification. Since alkali metal ions, especially sodium ions, can catalyse melt transesterification, the amounts of sodium remaining in the mixture must, however, be known exactly and determined if necessary. It is therefore advantageous when no catalyst including alkali metal ion is used in process step (ii).

The at least one catalyst is more preferably an organic base, preferably alkylamines, imidazole (derivatives), guanidine bases such as triazabicyclodecene, DMAP and corresponding derivatives, 1,5-diazabicyclo[4.3.0]non-5-ene (DBN) and diazabicycloundecene (DBU), most preferably DMAP. These catalysts bring the particular advantage that they can be removed by means of the reduced pressure applied in process step (iii) according to the invention. This means that the resulting mixture comprising oligoesters contains only a small content of catalyst, or even none at all. This brings the particular advantage that there are no inorganic salts which, for example, are always obtained via a route in which phosgene is used in the mixture of oligoesters, and hence none in the later polyester carbonate either. It is known that such salts can have an adverse effect on the stability of the polyester carbonate, since the ions can act catalytically in the case of corresponding degradation.

Preference is given to using a mixture of at least one organic base, for example alkylamines, imidazole (derivatives), guanidine bases such as triazabicyclodecene, DMAP and corresponding derivatives, DBN or DBU together with a phosphonium catalyst of the formula (VIII) (see further down). The catalyst used in process step (ii) is most preferably a mixture of 4-(dimethylamino)pyridine (DMAP) and tetrabutylphosphonium acetate.

The at least one catalyst is preferably used in amounts of 1 to 5000 ppm, preferably 5 to 1000 ppm and more preferably 20 to 500 ppm, based on the sum total of the masses of isophthalic acid and/or terephthalic acid, of the diol of the formula (3) and of the diaryl carbonate of the formula (4). If more than one catalyst is used in the reaction, these catalysts are preferably used in amounts of 1 to 5000 ppm, preferably 5 to 1000 ppm and more preferably 300 to 700 ppm.

In process step (iii), reduced pressure is applied to the mixture obtained from process step (ii). As a result, the corresponding aryl alcohol of the diaryl carbonate used, preferably phenol, is distilled off and the equilibrium of the reaction is moved toward oligoesters. The aryl alcohol is the chemical compound eliminated by the condensation reaction.

The term “condensation” is known to a person skilled in the art. This is preferably understood to mean a reaction in which two molecules (of the same substance or different substances) combine to form a larger molecule, with elimination of a molecule of a chemically simple substance. This compound eliminated in the condensation is removed by means of reduced pressure in process step (iii). Accordingly, it is preferable that the process according to the invention is characterized in that, during process step (iii), the volatile constituents having a boiling point below that of the mixture of oligoesters formed in process step (ii) are removed, optionally with stepwise reduction of the pressure. Stepwise removal is preferably chosen when different volatile constituents are being removed. Stepwise removal is likewise preferably chosen in order to ensure that the volatile constituent(s) is/are removed as completely as possible. The volatile constituents are the chemical compound(s) eliminated in the condensation, preferably phenol.

The pressure can be reduced stepwise, for example, by lowering the pressure as soon as the overhead temperature falls, so as to ensure continuous removal of the chemical compound eliminated in the condensation.

The condensation product is removed in process step (iii) preferably at temperatures of 200° C. to 280° C., more preferably 210° C. to 270° C. and especially preferably 220° C. to 265° C. In addition, the reduced pressure in the course of removal is preferably 500 mbar to 0.01 mbar. It is especially preferable that the removal is effected stepwise by reducing the pressure. The vacuum in the final stage is most preferably 10 mbar to 0.01 mbar.

In a further aspect of the present invention, a polyester carbonate is provided, comprising
(A) ester groups of the formula (I)

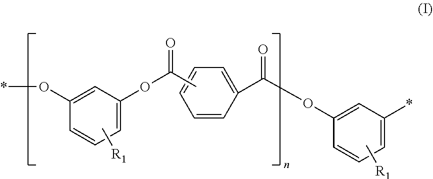

in which R₁ is in each case independently a hydrogen atom, a halogen or an alkyl group having 1 to 4 carbon atoms, preferably hydrogen, n is at least 4, preferably 4 to 30, more preferably 5 to 27, most preferably 5 to 24, and the “*” indicate the positions by which the ester groups are incorporated into the polyester carbonate,
(B) carbonate groups of the formula (II)

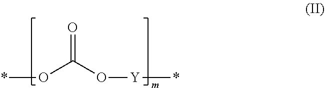

in which Y is in each case independently a structure of the formula (III), (IV), (V) or (VI), where

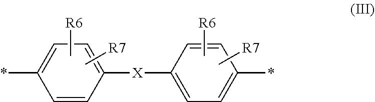

in which
R6 and R7 are each independently hydrogen, C₁-C₁₈ -alkyl, C₁-C₁₈-alkoxy, halogen or in each case optionally substituted aryl or aralkyl, preferably hydrogen, and
X is a single bond, —CO—, —O—, —S—, C₁- to C₆-alkylene, C₂- to C₅-alkylidene, C₆- to C₁₀-cycloalkylidene, or is C₆- to C₁₂-arylene which may optionally be fused to further aromatic rings containing heteroatoms, preferably a single bond, C₂- to C₅-alkylidene or C₆ to C₁₀-cycloalkylidene, more preferably isopropylidene,

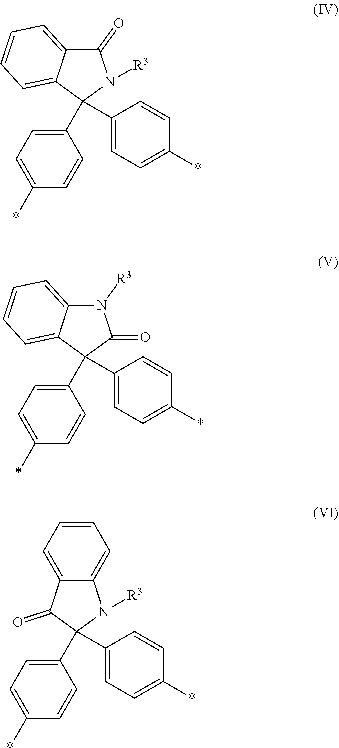

where, in these formulae (IV) to (VI), R³ in each case is C₁-C₄ alkyl, aralkyl or aryl, preferably methyl or phenyl, most preferably methyl, and
the “*” in each case indicate the positions by which the formulae (III), (IV), (V) or (VI) bind to the carbonate group in formula (II),
m is at least 5, preferably 8 to 300, more preferably 10 to 250 and most preferably 50 to 200, and the “*” each indicate the positions by which the carbonate groups are incorporated into the polyester carbonate,
characterized in that at least some of the ester groups (A) are joined directly to at least some of the carbonate groups (B) via the formula (VII), where

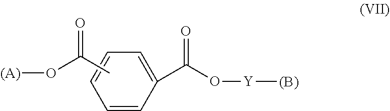

in which Y has the definitions described above for (B) and (A) represents the linkage to the ester group (A) and (B) represents the linkage to the carbonate group (B),
in that the polyester carbonate has a phenolic OH group content in the range from greater than 0 ppm to not more than 500 ppm and
in that the polyester carbonate has a relative solution viscosity of at least 1.255 to at most 1.35.

The presence of a structure of the formula (VII) can be determined via NMR. This is illustrated by way of example by a direct linkage of bisphenol units to isophthalic acid and/or terephthalic acid units. The linkage is an ester linkage. The presence of this linkage can be determined via ¹³C NMR spectroscopy by determining the chemical shift of the carbonyl carbon atom identified by an arrow in formula (VIIa).

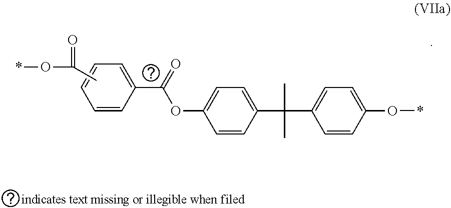

The Experimental gives a description by way of example of the synthesis of a model compound formed from bisphenol A and isophthalic acid/terephthalic acid in order to find/calibrate the position of the carbon identified by the arrow in formula (VIIa) in the ¹³C NMR.

Polyester carbonates produced by the interfacial process that comprise ester groups (A) and (B) do not have the structural formula (VII) (see FIG. 1). In such reactions, an OH-terminated oligoester reacts with a bisphenol (generally bisphenol A) or a corresponding oligocarbonate by reaction with phosgene to give a carbonate. This means that, for example, there is always a resorcinol unit bonded directly to a BPA unit via a carbonate group.

It will be apparent to the person skilled in the art that the ester groups (A) and carbonate groups (B) may each occur repeatedly in a polyester carbonate. It will likewise be apparent that n and m and the number of ester groups (A) and/or of carbonate groups (B) have to be chosen so as to result in the corresponding solution viscosity of the polyester carbonate. It is preferable here that the polyester carbonate according to the invention has a ratio of 5% to 90% by weight, more preferably 8% to 30% by weight and most preferably 9% to 25% by weight of ester groups (A) in relation to the total weight of ester groups (A) and of carbonate groups (B). It is likewise preferable that the polyester carbonate according to the invention consists at least to an extent of 80% by weight, more preferably at least to an extent of 90% by weight and most preferably at least to an extent of 95% by weight of the units of the formula (I) and (II).

It is preferable that the polyester carbonate according to the invention is characterized in that the polyester carbonate has a relative solution viscosity of at least 1.26 to at most 1.34. As already described above, this relative solution viscosity ensures good processibility of the polyester carbonate, for example by injection moulding. This relative solution viscosity likewise makes it possible to show good mechanical properties for fields of use that are of interest, such as automobile exteriors. The polyester carbonate has high stability and is intrinsically stable to weathering.

According to the present invention, relative solution viscosity (ηrel; also referred to as eta rel) is preferably determined using an Ubbelohde viscometer in dichloromethane at a concentration of 5 g/l at 25° C. The person skilled in the art is familiar with the determination of relative solution viscosity by means of an Ubbelohde viscometer. According to the invention, this is preferably carried out in accordance with DIN 51562-3; 1985-05. This involves measuring the flow times of the polyester carbonate to be analysed through the Ubbelohde viscometer in order to then ascertain the difference in viscosity between the polymer solution and its solvent. For this purpose, the Ubbelohde viscometer is first calibrated by analysing the pure solvents dichloromethane, trichloroethylene and tetrachloroethylene (always performing at least 3 and at most 9 measurements). This is followed by the calibration proper using the solvent dichloromethane. The polymer sample is then weighed out and dissolved in dichloromethane and then the flow time is determined three times for this solution. The average value for the flow times is corrected via the Hagenbach correction and the relative solution viscosity is calculated.

It is likewise preferable that the polyester carbonate according to the invention has a phenolic OH group content in the range of greater than 50 ppm and not more than 400 ppm, more preferably greater than 80 ppm and not more than 350 ppm. This phenolic OH group content is preferably determined via infrared spectroscopy. It may also, as described above in relation to the OH end groups of the mixture according to the invention, be determined via ¹H NMR. However, the signals here can overlap. It is therefore preferable that the phenolic OH group content is determined by means of infrared spectroscopy. For this purpose, the polyester carbonate is preferably dissolved in dichloromethane (2 g/50 ml) and determined by evaluating the band at a wavenumber of 3583 cm⁻¹. The calibration of the infrared device which is required for the purpose is known to the person skilled in the art.

It is preferable in accordance with the invention that R I in formula (I) is hydrogen. It is likewise preferable that Y in formula (II) is a structure of the formula (III).

It is additionally preferable that R6 and R7 in formula (III) are each independently hydrogen or C₁-C₁₂-alkyl, more preferably hydrogen or C₁-C₈-alkyl and most preferably hydrogen or methyl.

It is very particularly preferable that Y is introduced into the carbonate group (B) via diphenols selected from the group consisting of 4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane, more preferably via bisphenol A.

The polyester carbonate according to the invention can be processed as such to give all kinds of moulded articles. It may also be processed with other thermoplastics and/or polymer additives to give thermoplastic moulding compounds. The moulding compounds and moulded articles are further provided by the present invention. The polymer additives are preferably selected from the group consisting of flame retardants, anti-drip agents, flame retardant synergists, smoke inhibitors, lubricants and demoulding agents, nucleating agents, antistats, conductivity additives, stabilizers (e.g. hydrolysis, heat ageing and UV stabilizers, and transesterification inhibitors), flow promoters, phase compatibilizers, dyes and pigments, impact modifiers, and fillers and reinforcers.

The thermoplastic moulding compounds may, for example, be produced in a known manner by mixing the polyester carbonate and the further constituents and melt-compounding and melt-extruding them at temperatures of preferably 200° C. to 320° C. in conventional apparatus, for example internal kneaders, extruders and twin-shaft screw systems. In the context of the present application, this process is generally referred to as compounding. The term “moulding compound” is thus understood to mean the product obtained when the constituents of the composition are melt-compounded and melt-extruded.

The moulded articles formed from the polyester carbonate according to the invention or from the thermoplastic moulding compounds comprising the polyester carbonate can be produced, for example, by injection moulding, extrusion and blow-moulding processes. A further form of processing is the production of mouldings by thermoforming from previously produced sheets or films.

In a further aspect of the present invention, a process for producing the polyester carbonate according to the invention is provided, characterized in that the mixture according to the invention, comprising oligoesters, is reacted with a mixture of oligocarbonates by melt transesterification.

The process of melt transesterification is known per se to the person skilled in the art. Reference may be made here for example to Schnell, “Chemistry and Physics of Polycarbonates”, Polymer Reviews, Volume 9, Interscience Publishers, New York, London, Sydney 1964. In particular, this is a process that can be conducted without solvents and/or phosgene. For this purpose, it is necessary to melt the mixture comprising oligoesters, and also the mixture of oligocarbonates. Suitable temperatures for this purpose are generally 280° C. to 400° C., preferably 300° C. to 390° C., more preferably 305° C. to 350° C. and further preferably 310° C. to 340° C. However, it has been found in accordance with the invention that temperatures of less than 320° C., preferably greater than 280° C. to 315° C., are advantageous in relation to the incorporation of the oligoester block into the polyester carbonate. This is true especially when mixtures comprising oligoesters that have a high OH end group content within the range defined in accordance with the invention are used.

At the same time, a reduced pressure is applied in order to shift the reaction equilibrium toward the polyester carbonate side. Pressures used for this purpose are preferably from 0.001 mbar to 50 mbar, more preferably from 0.005 to 40 mbar, even more preferably from 0.02 to 30 mbar and further preferably from 0.03 to 5 mbar.

It is preferable here that the mixture of oligocarbonates has a content of phenolic OH groups of 250 ppm to 2500 ppm, preferably 500 to 2400 ppm, and especially preferably from 1000 to 2300 ppm. The determination of the phenolic OH group content has already been described above.

It is likewise preferable that the mixture of oligocarbonates has a relative solution viscosity of 1.08 to 1.22, preferably 1.11 to 1.22, preferably 1.13 to 1.20. The determination of the relative solution viscosity has also already been described above.

The person skilled in the art will be able to select the chemical nature of the oligocarbonates so as to result in the carbonate groups (B) of the polyester carbonate according to the invention. Particular preference is given to bisphenol A-based oligocarbonates.

The process according to the invention is preferably conducted in the absence of a catalyst. This has the advantage that the catalyst need not be removed from the polyester carbonate obtained and does not remain therein. According to the catalyst, this can influence the stability of the polyester carbonate. The process according to the invention can also be performed in the presence of a catalyst, especially preferably in the presence of a basic catalyst.

Suitable catalysts include all inorganic or organic basic compounds, for example the hydroxides, carbonates, halides, phenoxides, diphenoxides, fluorides, acetates, phosphates, hydrogenphosphates and borates of lithium, sodium, potassium, cesium, calcium, barium and magnesium, nitrogen and phosphorus bases such as for example tetramethylammonium hydroxide, tetramethylammonium acetate, tetramethylammonium fluoride, tetramethylammonium tetraphenylborate, tetraphenylphosphonium fluoride, tetraphenylphosphonium tetraphenylborate, dimethyldiphenylammonium hydroxide, tetraethylammonium hydroxide, cetyltrimethylammonium tetraphenylborate, cetyltrimethylammonium phenoxide, 1,8-diazabicyclo[5.4.0]undec-7-ene (DBU), 1,5-diazabicyclo[4.3.0]non-5-ene (DBN) or guanidine systems such as for example 1,5,7-triazabicyclo[4.4.0]dec-5-ene, 7-phenyl-1,5,7-triazabicyclo[4.4.0]dec-5-ene, 7-methyl-1,5,7-triazabicyclo[4.4.0]dec-5-ene, 7,7′-hexylidenedi-1,5,7-triazabicyclo[4.4.0]dec-5-ene, 7,7′-decylidenedi-1,5,7-triazabicyclo[4.4.0]dec-5-ene, 7,7′-dodecylidenedi-1,5,7-triazabicyclo[4.4.0]dec-5-ene or phosphazenes such as for example the phosphazene base P1-t-oct=tert-octyliminotris(dimethylamino)phosphorane, the phosphazene base P1-t-butyl=tert-butyliminotris(dimethylamino)phosphorane and BEMP=2-tert-butylimino-2-diethylamino-1,3-dimethylperhydro-1,3,2-diaza-2-phosphorane.

Especially suitable are phosphonium catalysts of formula (VIII):

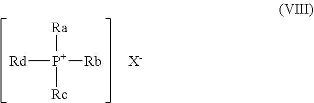

wherein Ra, Rb, Rc and Rd may be identical or different C1-C10-alkyls, C6-C14-aryls, C7-C15-arylalkyls or C5-C6-cycloalkyls, preferably methyl or C6-C14-aryls, particularly preferably methyl or phenyl, and X- may be an anion such as hydroxide, sulfate, hydrogensulfate, hydrogencarbonate, carbonate or a halide, preferably chloride or an alkoxide or aroxide of formula —OR, wherein R may be C6-C14-aryl, C7-C15-arylalkyl or C5-C6-cycloalkyl, preferably phenyl.

Particularly preferred catalysts are tetraphenylphosphonium chloride, tetraphenylphosphonium hydroxide and tetraphenylphosphonium phenoxide; tetraphenylphosphonium phenoxide is very particularly preferred. Likewise preferred is tetrabutylphosphonium acetate.

These catalysts are preferably used in amounts of 10² to 10⁸ mol, based on 1 mol of the mixture of oligoesters. The amounts of alkaline salts used as co-catalyst may be in the range from 1 to 500 ppb, preferably 5 to 300 ppb and particularly preferably 5 to 200 ppb.

In a further aspect of the present invention, a polyester carbonate obtained by the above-described process according to the invention in all disclosed combinations and preferred forms is provided.

### BRIEF DESCRIPTION OF THE DRAWING

FIG. 1: Detail from a ¹³C NMR spectrum of a commercial product containing isophthalic acid/terephthalic acid-resorcinol ester blocks and BPA, prepared by means of an interfacial process

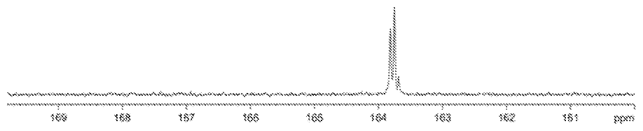

### DETAILED DESCRIPTION

### Examples

### Materials Used:

Terephthalic acid: for synthesis, CAS 100-21-0, Bernd Kraft Duisburg
Isophthalic acid: 99%, CAS 121-91-5, Sigma-Aldrich
Resorcinol: 99%, CAS 108-46-3, ABCR
Diphenyl carbonate: diphenyl carbonate, 99.5%, CAS 102-09-0; Acros Organics, Geel, Belgium, abbreviated to DPC
4-Dimethylaminopyridine: 4-dimethylaminopyridine; >98.0%; purum; CAS 1122-58-3; Sigma-Aldrich, Munich, Germany, abbreviated to DMAP
Tetrabutylphosphonium acetate: CAS-34430-94-9, prepared according to Angewandte Chemie, International Edition, Vol. 48, Issue: 40, 7398-7401; 2009
Sodium benzoate: >99%, CAS 532-32-1, Sigma-Aldrich
Oligocarbonate: The starting material used for the preparation of the polyester carbonate was linear bisphenol A oligocarbonate containing phenyl end groups and phenolic OH end groups with a relative solution viscosity of 1.17. This oligocarbonate does not contain any additives such as UV stabilizers, mould release agents or thermal stabilizers. The oligocarbonate was prepared via a melt transesterification method as described in WO02085967A1, and was removed immediately at the exit from the first horizontal reactor. The oligocarbonate has a phenolic end group content of 0.16% by weight.

### Analytical Methods:

### Solution Viscosity:

Determination of solution viscosity: Relative solution viscosity (ηrel; also referred to as eta rel) was determined in dichloromethane at a concentration of 5 g/l at 25° C. with an Ubbelohde viscometer.

### GPC:

Molecular weights were determined by means of gel permeation chromatography with dichloromethane as eluent. The standard used was BPA polycarbonate. The signal from the refractive index detector was used.

The corresponding method is defined under No. 2301-0257502-09D at Currenta GmbH & Co. OHG, which can be requested at any time from Currenta.

The oligomer content was likewise determined via GPC. This was done using the refractive index signal (RID). The oligomer range was defined as the range of molecular weight distribution of <1000 g/mol. The range of <1000 g/mol was evaluated as an area percentage via integration by comparison with the total area of the distribution curve.

### Determination of the Phenolic OH end Group Content:

By infrared spectroscopy: The polyester carbonate, dissolved in dichloromethane (2 g/50 ml; 1 mm quartz cuvette), was analysed in a Nicolet iS10 FT infrared spectrometer from Thermo Fisher Scientific. The phenolic OH end group content was determined by evaluating the band at wavenumber 3583 cm⁻¹. By ¹H NMR spectroscopy: The measurement was conducted in dichloromethane with tetramethylsiloxane as internal standard. The OH group content is reported in % by weight relative to the oligomer. For evaluation, the signal of the OH group was integrated and expressed in relation to the signals from the oligomer. Typically, the resonance of the OH group of the oligomer is between 5.3-5.6 ppm. (However, the person skilled in the art is aware that the OH signal in the NMR can move according to conditions such as water content in the solvent.)

The ratio of the phenyl end groups to OH end groups was determined by ¹H NMR spectroscopy (Bruker, 700 MHz). The measurement was conducted in dichloromethane with tetramethylsiloxane as internal standard. The area of the peak at about 7.4 ppm (2 protons) was expressed here relative to the area of the peak between 6.6 and 6.8 ppm (3 protons).

The linkage of isophthalic acid and/or terephthalic acid units and bisphenol A (see chemical formula (VII)) was detected via ¹³C NMR spectroscopy.

The carbonyl carbon atom shows a shift at 164-165 ppm, whereas the isophthalic acid and/or terephthalic acid resorcinol ester shows a signal at about 163-164 ppm.

The measurement was conducted using a Bruker Avance III HD 600 MHz NMR spectrometer. The measurement was conducted in CDC1 3 with tetramethylsilane as standard.

### Preparation of a Model Ester Compound from BPA and Terephthalic Acid/Isophthalic Acid

21.9 mmol of BPA and a total of 21.9 mmol of the diphenyl ester formed from terephthalic acid and isophthalic acid formed an initial charge in a multineck round-bottom flask. 2.4 mg of the tetrabutylphosphonium acetate was added, which corresponded to 0.02% of the total mass. The contents of the flask were freed from oxygen by evacuating and inertizing with nitrogen four times. The mixture was heated to 200° C. with constant stirring. Continuous formation of condensate took place. With increasing phenol formation, the initially cloudy, liquid mixture became increasingly clearer. An orange colour was established, which increased in intensity as the temperature was increased up to 230° C. About 80 min after commencement of the reaction, the pressure was reduced to 10 to 100 mbar in order to remove the phenol. The homogeneous, orange-brownish product was removed.

¹³C NMR (600 MHz): 164.2-164.5 ppm (m, 1 C); IPS/TPS-BPA ester C atom (linkage of the isophthalic acid and/or terephthalic acid units and resorcinol)

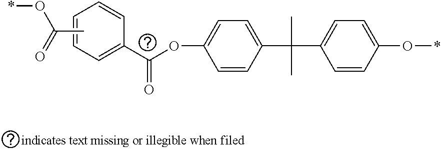

This substance was prepared in order to unambiguously identify the signal from the ester carbon atom that characterizes the ester formed from BPA and terephthalic acid or isophthalic acid. It was shown that the corresponding signal is at 164.2 to 164.5 ppm.

### PREPARATION of the OLIGOESTERS for COMPARATIVE EXAMPLES

### Example 1

A flask with a short-path separator was charged with 24.93 g (0.15 mol) of terephthalic acid, 24.93 g (0.15 mol) of isophthalic acid, 42.94 g (0.39 mol) of resorcinol, and also 130.46 g (0.609 mol) of diphenyl carbonate and 0.0447 g of DMAP (4-dimethylaminopyridine; 200 ppm based on the starting materials), and 9.9 μl of an aqueous solution of sodium benzoate (131.37 g/l), corresponding to approx. 1 ppm of sodium. The mixture was freed of oxygen by evacuating and filling with nitrogen four times. The mixture was melted and heated to 200° C. at standard pressure with stirring. The result was a suspension since terephthalic acid at first did not dissolve in the melt. The reaction mixture was stirred at that temperature for about 3 hours. This released carbon dioxide. The mixture was heated gradually to 240° C. Phenol was distilled off. The mixture was stirred at 240° C. for about 1 hour. Finally, the mixture was stirred at 260° C. for another half an hour. After the evolution of gas had ended, the reaction mixture was cooled down to 210° C. and the pressure was reduced. The pressure was reduced stepwise to 60 mbar within 45 minutes. The temperature was raised to 230° C. and the mixture was stirred at that temperature for half an hour. Then the temperature was raised to 245° C. The reaction mixture was stirred for a further 0.5 h and then the pressure was reduced to the technically feasible minimum (about 1 mbar). This gave a light brown melt. The analytical data are summarized in Table 1.

### Example 2

The example was basically conducted like Example 1.

In a departure from Example 1, a flask with a short-path separator was charged with 26.18 g (0.1575 mol) of terephthalic acid, 26.18 g (0.1575 mol) of isophthalic acid, 33.03 g (0.30 mol) of resorcinol, and also 141.69 g (0.6615 mol) of diphenyl carbonate and 0.0441 g of DMAP (4-dimethylaminopyridine; 200 ppm based on the starting materials), and 9.9 μl of an aqueous solution of sodium benzoate (131.37 g/l), corresponding to approx. 1 ppm of sodium.

In a departure from Example 1, an oligoester of greenish colour was obtained.

### Example 3

The example was basically conducted like Example 1.

In a departure from Example 1, a flask with a short-path separator was charged with 8.31 g (0.0500 mol) of terephthalic acid, 8.31 g (0.0500 mol) of isophthalic acid, 11.56 g (0.105 mol) of resorcinol, and also 43.91 g (0.205 mol) of diphenyl carbonate and 0.0144 g of DMAP (4-dimethylaminopyridine; 200 ppm based on the starting materials), and 3.2 μd of an aqueous solution of sodium benzoate (131.37 g/l), corresponding to approx. 1 ppm of sodium.

The mixture was melted at 160° C. and heated to 260° C. as quickly as permitted by the evolution of gas. Once no further gas was released and the suspension had been converted to a solution, there was a hold phase for 0.5 h. The vacuum phase was effected analogously to Example 1.

### Example 4

The example was basically conducted like Example 1.

In a departure from Example 1, a flask with a short-path separator was charged with 24.93 g (0.1500 mol) of terephthalic acid, 24.93 g (0.1500 mol) of isophthalic acid, 42.94 g (0.39 mol) of resorcinol, and 130.46 g (0.609 mol) of diphenyl carbonate and 0.04465 g of DMAP (4-dimethylaminopyridine; 200 ppm based on the feedstocks).

The oligoester prepared with these modified preparation parameters had similar characteristics to the counterpart with sodium, except for the OH concentration.

### Example 5

The product from Ex. 4 was dissolved in dichloromethane and then precipitated in methanol.

### Example 6

The example was basically conducted like Example 2.

In a departure from Example 2, a flask with a short-path separator was charged with 25.35 g (0.1525 mol) of terephthalic acid, 25.35 g (0.1525 mol) of isophthalic acid, 33.03 g (0.30 mol) of resorcinol, and 131.73 g (0.609 mol) of diphenyl carbonate and 0.0858 g of DMAP (4-dimethylaminopyridine; 400 ppm based on the feedstocks).

The oligoester prepared with these modified preparation parameters had similar characteristics to the counterpart with sodium.

### PREPARATION OF THE OLIGOESTERS FOR INVENTIVE EXAMPLES

### Example 7

The oligoester from Example 6 was dissolved in dichloromethane and then precipitated in methanol.

### Example 8

The example was basically conducted like Example 1.

In a departure from Example 1, a flask with a short-path separator was charged with 20.77 g (0.125 mol) of terephthalic acid, 20.77 g (0.125 mol) of isophthalic acid, 28.90 g (0.2625 mol) of resorcinol, and 109.79 g (0.5125 mol) of diphenyl carbonate and 0.036 g of DMAP (4-dimethylaminopyridine; 200 ppm based on the feedstocks), and 0.054 g tetrabutylphosphonium acetate (300 ppm).

The experimental procedure was analogous to Example 1. By contrast with Examples 2-7, the product had a distinctly increased melt viscosity on removal.

### Example 9

The example was basically conducted like Example 1.

In a departure from Example 1, a flask with a short-path separator was charged with 20.77 g (0.125 mol) of terephthalic acid, 20.77 g (0.125 mol) of isophthalic acid, 30.28 g (0.275 mol) of resorcinol, and 109.79 g (0.5125 mol) of diphenyl carbonate and 0.036 g of DMAP (4-dimethylaminopyridine; 200 ppm based on the feedstocks), and 0.054 g tetrabutylphosphonium acetate (300 ppm).

The experimental procedure was analogous to Example 1.

TABLE 1

| | | | | OH | Phenyl/ | Oligomer |
|---|---|---|---|---|---|---|
| | | | | content | OH | content |
| | Mn | D (poly- | Na | % by wt. | end | Area % |
| Ex. no. | (g/mol) | dispersity) | [ppm] | (NMR) | group | (RID) |
| Ex. 1 (for | 2100 | 3.05 | 1 | 0.6 | 0.7:1 | 7.1 |
| CE) | | | | | | |
| Ex. 2 (for | 1500 | 1.89 | 1 | 0.2 | 11.5:1 | 14.7 |
| CE) | | | | | | |
| Ex. 3 (for | 750 | 2.33 | 1 | 0.85 | 1.5:1 | 28.7 |
| CE) | | | | | | |
| Ex. 4 (for | 2800 | 2.01 | 0 | 0.80 | 0.5:1 | 6.4 |
| CE) | | | | | | |
| Ex 5 (for | 3000 | 1.96 | 0 | 0.70 | 0.5:1 | 5.4 |
| CE) (Ex. 4 | | | | | | |
| precipitated) | | | | | | |
| Ex. 6 (for | 1500 | 1.97 | 0 | 0.40 | 5.2:1 | 14.6 |
| CE) | | | | | | |
| Ex. 7 (for | 1700 | 1.8 | 0 | 0.3 | 5.2:1 | 9.9 |
| IE) (Ex.6 | | | | | | |
| precipitated) | | | | | | |
| Ex. 8 (for | 4200 | 1.95 | 0 | 0.1 | 7.8:1 | 2.4 |
| IE) | | | | | | |
| Ex. 9 (for | 2700 | 2.21 | 0 | 0.2 | 4.8:1 | 5.8 |
| IE) | | | | | | |

(n. b. stands for ″not determined″)

EXAMPLES OF POLYESTER CARBONATE SYNTHESIS FROM OLIGOCARBONATE AND OLIGOESTER BLOCKS FROM EXAMPLES 1-9

### Example 10 (Comparative Example)

A flask with a short-path separator was charged with 32.0 g (80% by weight) of oligocarbonate and 8.0 g (20% by weight) of the oligocarbonate from Example 1. The mixture was freed of oxygen by evacuating and filling with nitrogen four times. The mixture was melted at 160° C. under standard pressure. Then the temperature was increased to 320° C. The pressure was reduced to the minimum technically possible (about 1.5 mbar). The temperature was increased stepwise to about 335° C. within 30 minutes; phenol was removed continuously. A transparent melt was obtained. The analytical data are presented in Table 2.

### Example 11 (Comparative Example)

The experiment was conducted as described in Example 10. The difference was that 36.0 g of oligocarbonate (90% by weight) and 4.0 g of oligoester (10% by weight) from Example 1 were used.

### Example 12

The experiment was conducted as described in Example 10. The difference was that the oligocarbonate from Example 2 was used.

### Example 13

The experiment was conducted as described in Example 10. The difference was that 36.0 g of oligocarbonate (90% by weight) and 4.0 g of oligoester (10% by weight) from Example 2 were used.

### Example 14

The experiment was conducted as described in Example 10. The difference was that the oligocarbonate from Example 3 was used.

### Example 15

The experiment was conducted as described in Example 10. The difference was that 36.0 g of oligocarbonate (90% by weight) and 4.0 g of oligoester (10% by weight) from Example 3 were used.

### Example 16

The experiment was conducted as described in Example 10. The difference was that 36.0 g of oligocarbonate (90% by weight) and 4.0 g of oligoester (10% by weight) from Example 4 were used.

### Example 17

The experiment was conducted as described in Example 10. The difference was that the oligocarbonate from Example 4 was used.

### Example 18

The experiment was conducted as described in Example 10. The difference was that 36.0 g of oligocarbonate (90% by weight) and 4.0 g of oligoester (10% by weight) from Example 5 were used.

### Example 19

The experiment was conducted as described in Example 10. The difference was that the oligocarbonate from Example 5 was used.

### Example 20

The experiment was conducted as described in Example 10. The difference was that 36.0 g of oligocarbonate (90% by weight) and 4.0 g of oligoester (10% by weight) from Example 6 were used. The increase in viscosity was smaller compared to the previous examples.

### Example 21

The experiment was conducted as described in Example 10. The difference was that the oligocarbonate from Example 5 was used. The increase in viscosity was smaller compared to the previous examples.

### Example 22

The experiment was conducted as described in Example 10. The difference was that 36.0 g of oligocarbonate (90% by weight) and 4.0 g of oligoester (10% by weight) from Example 7 were used.

### Example 23

The experiment was conducted as described in Example 10. The difference was that the oligocarbonate from Example 7 was used.

### Example 24

The experiment was conducted as described in Example 10. The difference was that 36.0 g of oligocarbonate (90% by weight) and 4.0 g of oligoester (10% by weight) from Example 8 were used.

### Example 25

The experiment was conducted as described in Example 10. The difference was that the oligocarbonate from Example 8 was used.

### Example 26

The experiment was conducted as described in Example 10. The difference was that 36.0 g of oligocarbonate (90% by weight) and 4.0 g of oligoester (10% by weight) from Example 9 were used.

### Example 27

The experiment was conducted as described in Example 10. The difference was that the oligocarbonate from Example 9 was used.

TABLE 2

| | Oligoester used | | Phenol OH |
|---|---|---|---|
| Ex. no. | (proportion in %) | Eta rel | (IR) ppm |
| 10 (comparative) | Ex. 1; 20% | 1.406 | 520 |
| 11 (comparative) | Ex. 1; 10% | 1.369 | 490 |
| 12 (comparative) | Ex. 2; 20% | 1.282 | 620 |
| 13 (comparative) | Ex. 2; 10% | 1.246 | 290 |
| 14 (comparative) | Ex. 3; 20% | 1.412 | 370 |
| 15 (comparative) | Ex. 3; 10% | 1.515 | 530 |
| 16 (comparative) | Ex. 4; 10% | 1.27 | 900 |
| 17 (comparative) | Ex. 4; 20% | 1.319 | 740 |
| 18 (comparative) | Ex. 5; 10% | 1.337 | 510 |
| 19 (comparative) | Ex. 5; 20% | 1.36 | 590 |
| 20 (comparative) | Ex. 6; 10% | 1.247 | 400 |
| 21 (comparative) | Ex. 6; 20% | 1.249 | 160 |
| 22 (inv.) | Ex. 7; 10% | 1.329 | 230 |
| 23 (inv.) | Ex. 7; 20% | 1.32 | 100 |
| 24 (inv.) | Ex. 8; 10% | 1.323 | 260 |
| 25 (inv.) | Ex. 8; 20% | 1.304 | 190 |
| 26 (inv.) | Ex. 9; 10% | 1.293 | 300 |
| 27 (inv.) | Ex. 9; 20% | 1.26 | 250 |

Experiments with Na Catalyst

In Example 1, a predominantly OH-terminated oligoester is obtained (0.6% by weight of OH). The GPC of the oligoester shows only a low level of oligomers in the range of <1000 g/mol. This oligoester was used in Examples 1 and 2. The respective end products show relatively high phenolic OH values — 500 ppm is exceeded in Example 1. This thus shows that the ester block is not very suitable, since it is not possible in every case to obtain products below 500 ppm. Even though Example 2 has an OH value of less than 500 ppm, the viscosity and hence molecular weight are very high. It is therefore very likely that limit of 500 ppm will be exceeded in the case of correspondingly lower molecular weights.

In Example 2, an oligoester with a low OH content was prepared (0.2% by weight). This block is predominantly phenyl-terminated. However, this block contains distinct amounts of oligomers in the range of <1000 g/mol. Like Example 13, in which the oligoester block from Example 2 was used, the increase in molecular weight is small compared to the other examples. It is thus found that the activity is lower in the case of phenyl-terminated blocks that have a relatively high content of oligomers. It was surprising that, in spite of use of a catalyst, the desired molecular weight could not be achieved.

In Example 3, an oligoester with a relatively high OH content (0.85% by weight) was prepared. This product additionally has a relatively high oligomer content in the range of <1000 g/mol. Example 15 shows that the corresponding polyester carbonate has phenolic OH values of >500 ppm. It is thus not possible to produce the full range of polyester carbonates with a different ester content.

Example 4 shows an oligoester which is predominantly OH-terminated (0.80% by weight of OH). Examples 16 and 17 have relatively high molecular weights (without the need to use a catalyst), and thus show that OH-terminated blocks have high reactivity. However, the corresponding end products, both in the case of an ester block content of 10% and 20%, have high contents of phenolic OH end groups (>500 ppm).

In Example 5, the ester block obtained from Example 4 is precipitated. The content of phenolic OH end groups thus falls from 0.8% to 0.7% by weight. However, even with this block, it is not possible to produce products having acceptable OH contents (see Examples 18 and 19).

In Example 6, an oligoester block with an acceptable OH content is used. However, the content of oligomers in the range of <1000 g/mol is relatively high. As in Example 13, the reactivity here too (Examples 20 and 21) is low, and so the target range in the molecular weight could not be attained.

In Inventive Examples 22 and 23, proceeding from an oligoester block (from Example 7), polyester carbonates having a low proportion of phenolic OH groups are prepared. It is thus found that, when oligoesters having a moderate OH content are used, polyester carbonates according to the objective can be prepared. In spite of the relatively low OH content of the oligoester block, it was surprisingly possible to achieve relatively high molecular weights in the polyester carbonate.

Surprisingly, even in the case of very low OH contents (oligoester block from Example 8), it was possible to achieve high molecular weights in the polyester carbonate (Examples 24 and 25). Moreover, the resulting materials have low OH contents.

Inventive Examples 26 and 27 likewise have low OH contents. Here, an oligoester block with 0.2% by weight of phenolic OH groups was used.

1. A mixture comprising oligoesters of the formula (I) 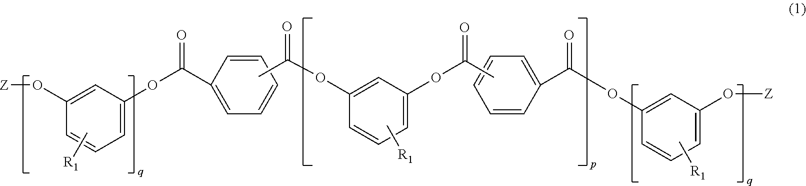
where each R₁ is independently a hydrogen atom, a halogen or an alkyl group having 1 to 4 carbon atoms,
each q is independently 0 or 1,
if q=1: each Z is independently —H or an aromatic radical of the formula (2a) 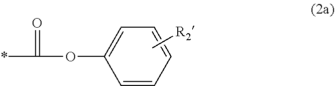
where R₂ is hydrogen or is —COOCH₃ and “*” indicates the position by which the formula (2a) is bonded to the oxygen atom in the formula (1),
if q=0: each Z is independently an aromatic radical of the formula (2) 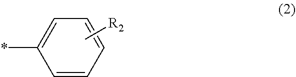
where R₂ is hydrogen or is —COOCH₃ and “*” indicates the position by which the formula (2) is bonded to the oxygen atom in the formula (1), and
p indicates the number of repeat units,
wherein not more than 0.5% by weight of the Z radicals in relation to the mixture are hydrogen and in that the percentage of oligomers having a molecular weight of less than 1000 g/mol in the mixture is less than 12%, where the percentage of oligomers is determined by the ratio of the area beneath a molecular weight distribution curve of the mixture in relation to the refractive index signal (from gel permeation chromatography) within a range below 1000 g/mol and the total area beneath that molecular weight curve, and where the gel permeation chromatography is conducted in dichloromethane with a bisphenol A polycarbonate standard.

2. The mixture according to claim 1, wherein,
R₁ in formula (I) is hydrogen,
not more than 0.4% by weight of the Z radicals in relation to the mixture are hydrogen and
the percentage of oligomers having a molecular weight of less than 1000 g/mol is less than 10%.

3. The mixture according to claim 1, wherein the mixture of oligoesters has a number-average molecular mass in the range from 1300 g/mol to 6000 g/mol.

4. A polyester carbonate comprising
(A) ester groups of the formula (I) 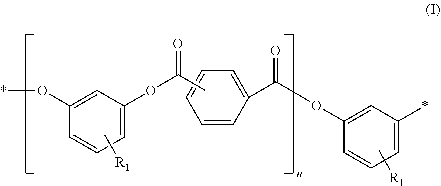
in which R₁ is in each case independently a hydrogen atom, a halogen or an alkyl group having 1 to 4 carbon atoms, n is at least 4, and the “*” indicate the positions by which the ester groups are incorporated into the polyester carbonate,
(B) carbonate groups of the formula (II) 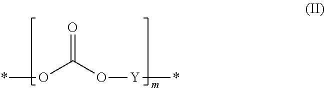
in which Y is in each case independently a structure of the formula (III), (IV), (V) or (VI), where 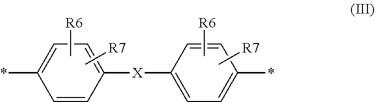
in which
R6 and R7 are each independently hydrogen, C₁-C₁₈-alkyl, C₁-C₁₈-alkoxy, halogen or in each case optionally substituted aryl or aralkyl, and
X is a single bond, —CO—, —O—, —S—, C₁- to C₆-alkylene, C₂- to C₅-alkylidene, C₆- to C₁₀-cycloalkylidene, or is C₆- to C₁₂-arylene which may optionally be fused to further aromatic rings containing heteroatoms, 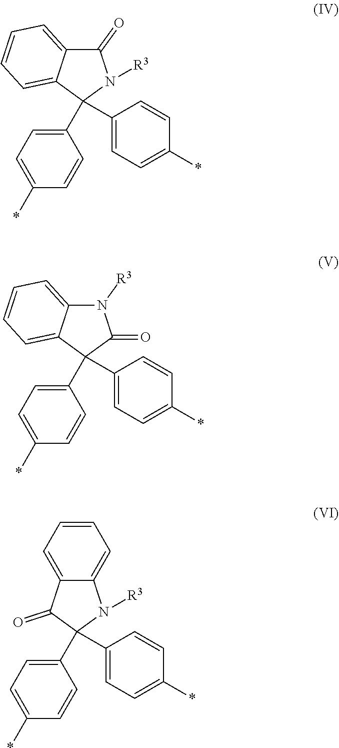
where, in these formulae (IV) to (VI), R³ in each case is C₁-C₄ alkyl, aralkyl or aryl-, and
the “*” in each case indicate the positions by which the formulae (III), (IV), (V) or (VI) bind to the carbonate group in formula (II),
m is at least 5 and the “*” in each case indicate the positions by which the carbonate groups are incorporated into the polyester carbonate,)
wherein at least some of the ester groups (A) are joined directly to at least some of the carbonate groups (B) via the formula (VII), where 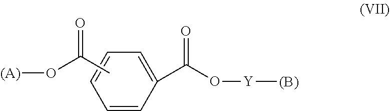
in which Y has the definitions described above for (B) and (A) represents the linkage to the ester group (A) and (B) represents the linkage to the carbonate group (B),
in that the polyester carbonate has a phenolic OH group content in the range from greater than 0 ppm to not more than 500 ppm and
in that the polyester carbonate has a relative solution viscosity of at least 1.255 to at most 1.35.

5. The polyester carbonate according to claim 4, wherein R₁ in formula (I) is hydrogen.

6. The polyester carbonate according to claim 4, wherein Y in formula (II) is a structure of the formula (III(.

7. The polyester carbonate according to claim 4, wherein R6 and R7 in formula (III) are each independently hydrogen or C₁-C₁₂-alkyl,

8. The polyester carbonate according to claim 4, where Y is introduced into the carbonate group (B) via diphenols selected from the group consisting of 4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane.

9. The polyester carbonate according to claim 4, wherein the polyester carbonate has a relative solution viscosity of at least 1.26 to at most 1.34.

10. The polyester carbonate according to claim 4, wherein the polyester carbonate has a content of phenolic OH groups in the range of greater than 50 ppm and not more than 400 ppm.

11. A moulding compound comprising a polyester carbonate according to claim 4.

12. A moulded article comprising a polyester carbonate according to claim 4.

13. A process for preparing a polyester carbonate, comprising a mixture comprising oligoesters according to claim 1 with a mixture of oligocarbonates by melt transesterification.

14. The process according to claim 14, wherein the mixture of oligocarbonates has a phenolic OH group content of 250 ppm to 2500 ppm.

15. The process according to claim 13, wherein the mixture of oligocarbonates has a relative solution viscosity of 1.08 to 1.22.
